(19) United States
(12) Patent Application Publication
(10) Pub. No.: US 2026/0063473 A1
(43) Pub. Date: Mar. 5, 2026

(54) WAVELENGTH DETECTION DEVICE, LASER DEVICE, AND ELECTRONIC DEVICE MANUFACTURING METHOD

(71) Applicant: Gigaphoton Inc., Oyama-shi (JP)

(72) Inventor: Kohei KUSAYANAGI, Oyama-shi (JP)

(73) Assignee: Gigaphoton Inc., Oyama-shi (JP)

(21) Appl. No.: 19/381,168

(22) Filed: Nov. 6, 2025

Related U.S. Application Data
(63) Continuation of application No. PCT/JP2023/022991, filed on Jun. 21, 2023.

(51) Int. Cl. G01J 3/45; G01J 3/02

(52) U.S. Cl. CPC G01J 3/45; G01J 3/0216; G01J 3/0286

(57) ABSTRACT

A wavelength detection device for an excimer laser includes a first housing accommodating a first etalon; a first heater arranged on an outer wall of the first housing, and configured to heat the first housing; a second housing connected to the first housing, and accommodating a first light concentrating optical system configured to cause light output from the first etalon to be imaged on a first sensor; a second heater arranged on an outer wall of the second housing, and configured to heat the second housing; and a processor configured to control a temperature of the first housing and a temperature of the second housing using the first heater and the second heater.

### CROSS-REFERENCE TO RELATED APPLICATIONS

The present application is a continuation application of International Application No. PCT/JP2023/022991, filed on Jun. 21, 2023, the entire contents of which are hereby incorporated by reference.

### BACKGROUND

### 1. Technical Field

The present disclosure relates to a wavelength detection device, a laser device, and an electronic device manufacturing method.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser device for exposure, a KrF excimer laser device for outputting laser light having a wavelength of about 248 nm and an ArF excimer laser device for outputting laser light having a wavelength of about 193 nm are used.

The KrF excimer laser device and the ArF excimer laser device each have a large spectral line width of about 350 to 400 μm in natural oscillation light. Therefore, when a projection lens is formed of a material that transmits ultraviolet rays such as KrF laser light and ArF laser light, there is a case in which chromatic aberration occurs. As a result, the resolution may decrease. Then, a spectral line width of laser light output from the gas laser device needs to be line-narrowed to the extent that the chromatic aberration can be ignored. For this purpose, there is a case in which a line narrowing module (LNM) including a line narrowing element (etalon, grating, and the like) is provided in a laser resonator of the gas laser device to line-narrow a spectral line width. In the following, a gas laser device with a narrowed spectral line width is referred to as a line narrowing gas laser device.

### LIST OF DOCUMENTS

### Patent Documents

Patent Document 1: U.S. Pat. No. 10,890,484
Patent Document 2: U.S. Pat. No. 7,196,796
Patent Document 3: U.S. Pat. No. 5,387,974

### SUMMARY

A wavelength detection device according to an aspect of the present disclosure is a wavelength detection device for an excimer laser, the wavelength detection device including a first housing accommodating a first etalon; a first heater arranged on an outer wall of the first housing, and configured to heat the first housing; a second housing connected to the first housing, and accommodating a first light concentrating optical system configured to cause light output from the first etalon to be imaged on a first sensor; a second heater arranged on an outer wall of the second housing, and configured to heat the second housing; and a processor configured to control a temperature of the first housing and a temperature of the second housing using the first heater and the second heater.

A laser device according to an aspect of the present disclosure includes a laser resonator configured to output ultraviolet laser light, and a wavelength detection device configured to detect a wavelength of the laser light. Here, the wavelength detection device includes a first housing accommodating a first etalon; a first heater arranged on an outer wall of the first housing, and configured to heat the first housing; a second housing connected to the first housing, and accommodating a first light concentrating optical system configured to cause light output from the first etalon to be imaged on a first sensor; a second heater arranged on an outer wall of the second housing, and configured to heat the second housing; and a processor configured to control a temperature of the first housing and a temperature of the second housing using the first heater and the second heater.

An electronic device manufacturing method according to an aspect of the present disclosure includes generating laser light using a laser device, outputting the laser light to an exposure apparatus, and exposing a photosensitive substrate to the laser light in the exposure apparatus to manufacture an electronic device. Here, the laser device includes a laser resonator configured to output the ultraviolet laser light, and a wavelength detection device configured to detect a wavelength of the laser light. The wavelength detection device includes a first housing accommodating a first etalon; a first heater arranged on an outer wall of the first housing, and configured to heat the first housing; a second housing connected to the first housing, and accommodating a first light concentrating optical system configured to cause light output from the first etalon to be imaged on a first sensor; a second heater arranged on an outer wall of the second housing, and configured to heat the second housing; and a processor configured to control a temperature of the first housing and a temperature of the second housing using the first heater and the second heater.

### BRIEF DESCRIPTION OF THE DRAWINGS

Embodiments of the present disclosure will be described below merely as examples with reference to the accompanying drawings.

FIG. 1 schematically shows the configuration of a laser device including a wavelength detection device according to a comparative example.

FIG. 2 is a front view showing an exterior example of a wavelength measurement unit applied to the wavelength detection device according to the comparative example.

FIG. 3 is a right side view of the wavelength measurement unit shown in FIG. 2.

FIG. 4 is a rear view of the wavelength measurement unit shown in FIG. 2.

FIG. 5 is a top view of the wavelength measurement unit shown in FIG. 2.

FIG. 6 is a configuration view of the wavelength detection device including a sectional view taken along line 6-6 of FIG. 2.

FIG. 7 is a graph showing a test result of measurement of the wavelength drift when the ambient temperature is changed by placing the monitor module including the wavelength detection device according to the comparative example in a thermostatic bath.

FIG. 8 is a sectional view schematically showing the configuration of the wavelength detection device according to a first embodiment.

FIG. 9 is a graph showing a test result of measurement of the wavelength drift when the ambient temperature is changed by placing the monitor module including the wavelength detection device according to the first embodiment in a thermostatic bath.

FIG. 10 is a sectional view schematically showing the configuration of the wavelength detection device according to a second embodiment.

FIG. 11 is a sectional view schematically showing the configuration of the wavelength detection device according to a modification of the second embodiment.

FIG. 12 is a sectional view schematically showing the configuration of the wavelength detection device according to a third embodiment.

FIG. 13 schematically shows the configuration of an exposure apparatus.

### DESCRIPTION OF EMBODIMENTS

### Contents

1. Overview of laser device including wavelength detection device according to comparative example
   1.1 Configuration
   1.2 Operation
   1.3 Exterior example of wavelength measurement unit
   1.4 Details of wavelength detection device
      1.4.1 Configuration
      1.4.2 Operation
      1.4.3 Effect
   1.5 Problem
2. First Embodiment
   2.1 Configuration
   2.2 Operation
   2.3 Effect
3. Second Embodiment
   3.1 Configuration
   3.2 Operation
   3.3 Effect
   3.4 Modification
      3.4.1 Configuration
      3.4.2 Operation
      3.4.3 Effect
4. Third Embodiment
   4.1 Configuration
   4.2 Operation
   4.3 Effect
   4.4 Modification
5. Electronic device manufacturing method
6. Others

Hereinafter, embodiments of the present disclosure will be described in detail with reference to the drawings. The embodiments described below show some examples of the present disclosure and do not limit the contents of the present disclosure. Also, all configurations and operation described in the embodiments are not necessarily essential as configurations and operation of the present disclosure. Here, the same components are denoted by the same reference numeral, and duplicate description thereof is omitted.

### 1. Overview of Laser Device Including Wavelength Detection Device According to Comparative Example

### 1.1 Configuration

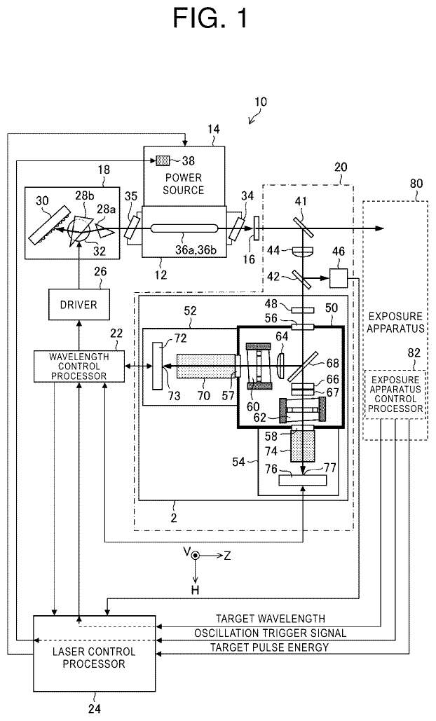

FIG. 1 schematically shows the configuration of a laser device 10 including a wavelength detection device 2 according to a comparative example. The comparative example of the present disclosure is an example recognized by the applicant as known only by the applicant, and is not a publicly known example admitted by the applicant. The laser device 10 shown in FIG. 1 is a line narrowing gas laser device used together with an exposure apparatus 80. The laser device 10 includes a laser chamber 12, a power source 14, an output coupling mirror 16, a line narrowing module (LNM) 18, a monitor module 20, a wavelength control processor 22, a laser control processor 24, and a driver 26.

The output coupling mirror 16 and the LNM 18 configure a laser resonator, and the laser chamber 12 is arranged on the optical path of the laser resonator. The LNM 18 includes a plurality (e.g., two) of prisms 28a, 28b, a grating 30, and a rotation stage 32. The prisms 28a, 28b are arranged to function as a beam expander. The grating 30 is arranged in the Littrow arrangement so that the incident angle and the diffraction angle coincide with each other. The prism 28b is arranged on the rotation stage 32, and is arranged such that the incident angle on the grating 30 changes by the rotation of the prism 28b. The driver 26 for driving the rotation stage 32 is connected to the wavelength control processor 22.

The laser chamber 12 includes windows 34, 35 and a pair of discharge electrodes 36a, 36b. The laser chamber 12 is filled with a laser gas including, for example, an Ar gas or a Kr gas as a rare gas, an F: gas as a halogen gas, and an Ne gas as a buffer gas.

The discharge electrodes 36a, 36b face each other in the laser chamber 12 in a direction (V direction) perpendicular to the plane of FIG. 1, and are arranged such that the longitudinal direction of the discharge electrodes 36a, 36b coincides with the optical path of the laser resonator.

The power source 14 includes a charger (not shown) and a pulse power module (not shown). The pulse power module includes a switch 38. The power source 14 is connected to the discharge electrodes 36a, 36b in the laser chamber 12 so as to apply a pulse high voltage between the discharge electrodes 36a, 36b when the switch 38 is turned ON. The discharge direction between the discharge electrodes 36a, 36b is a direction parallel to the V direction.

The windows 34, 35 are arranged at both ends of the laser chamber 12 such that the laser light amplified by the discharge excitation between the discharge electrodes 36a, 36b passes therethrough. The output coupling mirror 16 is coated with a film that reflects a part of the laser light and transmits another part. In FIG. 1, the travel direction of the laser light output from the output coupling mirror 16 is represented by a Z direction. The direction perpendicular to both the Z direction and the V direction is represented by a H direction.

The monitor module 20 includes beam splitters 41, 42, a light concentrating optical system 44, a pulse energy sensor 46, and the wavelength detection device 2. The wavelength detection device 2 includes a diffusion element 48, a first housing 50, a second housing 52, and a third housing 54.

The beam splitter 41 is arranged, on the optical path of the laser light output from the output coupling mirror 16, at a position such that the reflection light from the beam splitter 41 is input to the beam splitter 42. The beam splitter 42 is arranged at a position such that the reflection light from the beam splitter 42 is input to the pulse energy sensor 46.

The pulse energy sensor 46 may be, for example, a photodiode, a photoelectric tube, or a pyroelectric element. The diffusion element 48 is arranged in the vicinity of the concentration position of the light concentrating optical system 44. The diffusion element 48 may be, for example, an optical element made of synthetic quartz having one surface flat and the other surface processed to be ground-glass-like.

The first housing 50 includes windows 56, 57, 58, and is a sealed chamber that accommodates a fine etalon 60, a coarse etalon 62, a light concentrating optical system 64, diffusion elements 66, 67, and a beam splitter 68. The first housing 50 may be made by machining a metal having excellent thermal conductivity, such as aluminum.

The window 56 is an entrance window for allowing the laser light transmitted through the diffusion element 48 to enter the first housing 50. The window 57 is an exit window for outputting the light transmitted through the fine etalon 60 to the outside of the first housing 50. The window 58 is an exit window for outputting the light transmitted through the coarse etalon 62 to the outside of the first housing 50. Each of the windows 56, 57, 58 is sealed at a connection portion thereof with respect to the first housing 50 via an O-ring (not shown), and is arranged on the optical path of the laser light in the first housing 50.

The beam splitter 68 is arranged at a position such that the laser light transmitted through the diffusion element 48 and the window 56 is incident and the reflection light from the beam splitter 68 is input to the light concentrating optical system 64. The fine etalon 60 is arranged on the optical path of the concentrated light by the light concentrating optical system 64. The fine etalon 60 may be, for example, an air gap etalon. The diffusion elements 66, 67 are arranged on the optical path of the transmitted light through the beam splitter 68. The coarse etalon 62 is arranged on the optical path of the light output from the diffusion element 67. Nitrogen is enclosed at the internal space of the first housing 50.

The second housing 52 is arranged so as to cover the optical path of the light transmitted through the fine etalon 60 and the window 57. The second housing 52 accommodates a light concentrating optical system 70 and a line sensor 72.

The third housing 54 is arranged so as to cover the optical path of the light transmitted through the coarse etalon 62 and the window 58. The third housing 54 accommodates a light concentrating optical system 74 and a line sensor 76. Each of the second housing 52 and the third housing 54 may not be particularly sealed. Here, the focal length of the light concentrating optical system 74 is shorter than the focal length of the light concentrating optical system 70.

The line sensor 72 is arranged such that a sensor light receiving surface 73 coincides with the position of the focal plane of the light concentrating optical system 70, and the line sensor 76 is arranged such that a sensor light receiving surface 77 coincides with the position of the focal plane of the light concentrating optical system 74. Each of the line sensors 72, 76 may be a photodiode array in which a plurality of photodiodes are arranged one-dimensionally as light receiving elements that output detection signals corresponding to light intensities by photoelectric conversion.

In general, interference fringes of an etalon are expressed by Expression (1) below.

mλ=2nd*cos θ (1)

Here, λ is a wavelength of the laser light, n is a refractive index of the air gap, d is a distance between the mirrors, and m is an integer. Light incident on the etalon is transmitted through the etalon with a high transmittance at an incident angle θ satisfying Expression (1).

Here, a free spectral range FSRf of the fine etalon 60 and a free spectral range FSRc of the coarse etalon 62 satisfy Expression (2) below.

FSRf<FSRc (2)

Each of the fine etalon 60 and the coarse etalon 62 is an air gap etalon in which two mirrors each coated with a partial reflection film are optically contacted via a spacer. The free spectral range (FSR) corresponding to the distance between the interference fringes of the etalon is expressed by Expression (3) below.

FSR=λ²/(2nd) (3)

Generally, when the finesse of the etalon is F, the resolution R is expressed by R=FSR/F. When the finesses F is substantially fixed, the resolution R increases as FSR decreases. However, when FSR becomes small, the interference fringes become substantially the same in a case in which the wavelength changes by the amount of the FSR, and thus it cannot be distinguished by measurement using one etalon having small FSR. Therefore, when the wavelength is changed by about 500 μm and detected with high accuracy as in the case of an excimer laser, the wavelength can be measured with high accuracy by measuring, using the line sensor 72 and the line sensor 76, the interference fringes of the coarse etalon 62 having a relatively wide range of detectable wavelength change and the fine etalon 60 having high resolution.

FSRf may be, for example, 10 pm, and FSRc may be, for example, 500 pm.

The exposure apparatus 80 includes an exposure apparatus control processor 82. The exposure apparatus control processor 82 controls the exposure apparatus 80 such as the movement of a wafer stage of the exposure apparatus 80. The laser control processor 24 is connected to the exposure apparatus control processor 82 and the wavelength control processor 22. The wavelength control processor 22 is connected to the line sensors 72, 76.

The processor in the present specification, such as the wavelength control processor 22, the laser control processor 24, and the exposure apparatus control processor 82, is a processor including a memory in which a control program is stored and a central processing unit (CPU) which executes the control program. The processor is specifically configured or programmed to perform various processes included in the present disclosure. The processor may include an integrated circuit such as a field programmable gate array (FPGA) or an application specific integrated circuit (ASIC).

### 1.2 Operation

The exposure apparatus control processor 82 outputs, to the laser control processor 24, data of a target wavelength λt, data of a target pulse energy Et, and an oscillation trigger signal to the laser control processor 24. The data of the target wavelength λt is input to the laser control processor 24 for each pulse in synchronization with the oscillation trigger signal. The wavelength control processor 22 acquires the data of the target wavelength λt via the laser control processor 24. The laser control processor 24 outputs the oscillation trigger signal to the switch 38 of the power source 14 based on the oscillation trigger signal received from the exposure apparatus control processor 82.

The laser control processor 24 reads the data of the target pulse energy Et and the target wavelength λt from the exposure apparatus control processor 82. The laser control processor 24 transmits the charge voltage V to the power source 14 and transmits the target wavelength λt to the wavelength control processor 22 so that the pulse energy of the pulse laser light output from the laser device 10 becomes the target pulse energy Et. The laser control processor 24 turns on the switch 38 of the power source 14 when the oscillation trigger signal is received from the exposure apparatus control processor 82. When the switch 38 of the power source 14 is turned on, a high voltage is applied between the discharge electrodes 36a, 36b, and discharge is generated to excite the laser gas.

When the laser gas is excited, laser oscillation occurs in the laser resonator configured by the LNM 18 and the output coupling mirror 16, and line narrowed ultraviolet pulse laser light is output from the output coupling mirror 16. The pulse laser light output from the output coupling mirror 16 is split by the beam splitter 41. The pulse laser light transmitted through the beam splitter 41 enters the exposure apparatus 80. The pulse laser light reflected by the beam splitter 41 is incident on the beam splitter 42 via the light concentrating optical system 44, and enters the pulse energy sensor 46 and the diffusion element 48 as the reflection light from and the transmission light through the beam splitter 42, respectively.

The laser control processor 24 controls the charge voltage of the power source 14 based on the detection result of the pulse energy sensor 46 so that the pulse energy becomes the target pulse energy Et.

On the other hand, the pulse laser light diffused by the diffusion element 48 passes through the window 56 and enters the light concentrating optical system 64 and the diffusion elements 66, 67 as the reflection light by and the transmission light through the beam splitter 68, respectively.

The light output from the light concentrating optical system 64 enters the fine etalon 60. The light output from the diffusion elements 66, 67 enters the coarse etalon 62.

The interference fringes generated by the fine etalon 60 are received by the line sensor 72. The interference fringes generated by the coarse etalon 62 are received by the line sensor 76. Each of the line sensors 72, 76 measures the intensity distribution of the interference fringes for each pulse and transmits data to the wavelength control processor 22. The wavelength control processor 22 calculates the wavelength λ of the pulse laser light for each pulse from the data of the read intensity distribution.

The wavelength control processor 22 controls the rotation stage 32 of the prism 28b via the driver 26 so that the calculated wavelength A becomes the target wavelength λt.

By the above-described operation, the pulse energy and the oscillation wavelength of the pulse laser light output from the laser device 10 are stabilized to the target pulse energy Et and the target wavelength λt from the exposure apparatus 80.

Here, since the first housing 50 is sealed, the change in the refractive index between the air gaps of the fine etalon 60 and the coarse etalon 62 is suppressed. Thus, the error of the wavelength measurement due to the drift of each etalon is reduced.

### 1.3 Exterior Example of Wavelength Measurement Unit

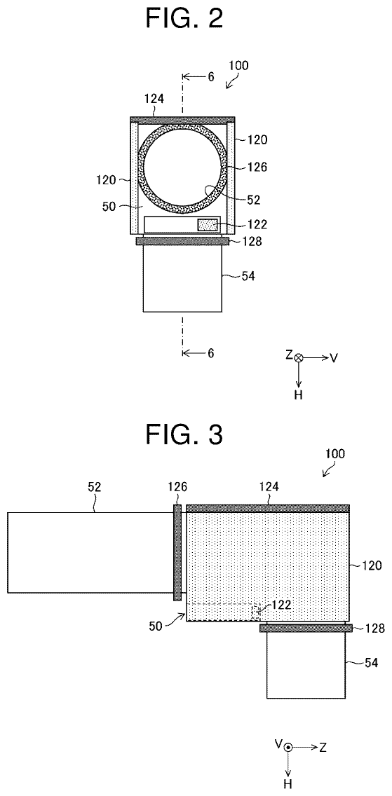

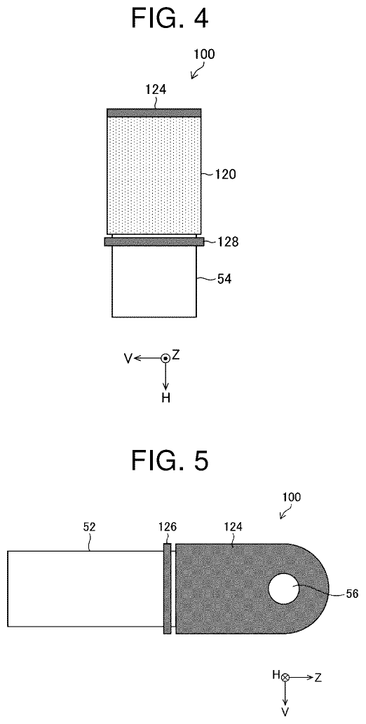

FIGS. 2 to 5 show an exterior example of the wavelength measurement unit 100 applied to the wavelength detection device 2. FIG. 2 is a front view, FIG. 3 is a right side view, FIG. 4 is a rear view, and FIG. 5 is a top view of the wavelength measurement unit 100. FIG. 2 is a view when the wavelength measurement unit 100 is viewed from the Z direction.

The wavelength measurement unit 100 has a structure in which the second housing 52 having a cylindrical shape and the third housing 54 having a cylindrical shape are connected to the first housing 50 having a box shape. The first housing 50 is a sealed chamber having an internal space configuring an etalon chamber sealed.

The first housing 50 is made of aluminum, and is manufactured by machining an aluminum block, for example. The second housing 52 and the third housing 54 may also be manufactured by machining an aluminum block in the same manner as the first housing 50. The second housing 52 is connected so as to extend in the −Z direction with respect to the first housing 50, and the third housing 54 is connected so as to extend in the H direction with respect to the first housing 50.

A rubber heater 120 and a temperature sensor 122 are arranged on the outer surface of the first housing 50, that is, the outer wall of the first housing 50. The rubber heater 120 is arranged so as to cover the back surface and the left and right side surfaces, being side wall surfaces parallel to the H direction, of the outer wall of the first housing 50.

The temperature sensor 122 is arranged on the outer surface of the etalon chamber in the vicinity of the coarse etalon 62 (see FIG. 1).

A heat insulating plate 124 is arranged on a surface where the rubber heater 120 is not arranged in the first housing 50, for example, on a surface where the window 56 is arranged in the first housing 50 (the upper surface of the first housing 50 in FIG. 2). Further, the first housing 50 and the second housing 52 are connected to each other with a heat insulating plate 126 interposed therebetween. The first housing 50 and the third housing 54 are connected with a heat insulating plate 128 interposed therebetween.

### 1.4 Details of Wavelength Detection Device

### 1.4.1 Configuration

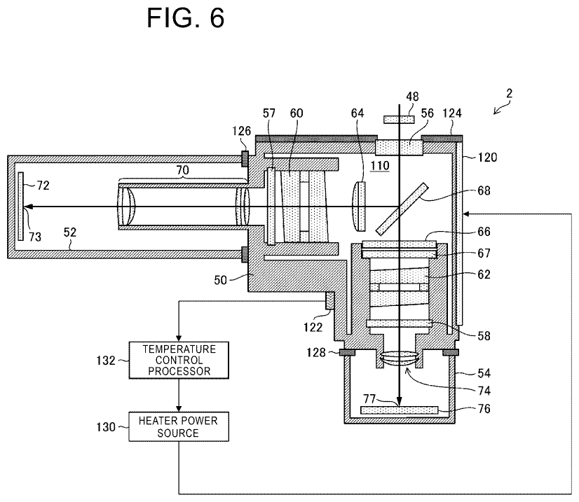

FIG. 6 is a configuration view of the wavelength detection device including a sectional view taken along line 6-6 of FIG. 2. As shown in FIG. 6, the light concentrating optical system 70 is arranged inside the second housing 52. Similarly, the light concentrating optical system 74 is arranged inside the third housing 54. The light concentrating optical systems 70, 74 are each configured by a lens set including a plurality of lenses. The window 57 is arranged between the fine etalon 60 and the light concentrating optical system 70. The window 58 is arranged between the coarse etalon 62 and the light concentrating optical system 74. The windows 57, 58 are wedged and arranged to seal the etalon chamber 110.

The rubber heater 120 is electrically connected to a heater power source 130, and the temperature sensor 122 is electrically connected to a temperature control processor 132. The temperature control processor 132 is also connected to the heater power source 130.

The temperature control processor 132 is a processor including a memory in which a control program is stored and a CPU which executes the control program. The temperature control processor 132 is specifically configured or programmed to perform various processes. The temperature control processor 132 may be integrated into the laser control processor 24.

### 1.4.2 Operation

The temperature control processor 132 controls the heat amount of the rubber heater 120 via the heater power source 130 so that the temperature measured by the temperature sensor 122 is within a constant temperature range, for example, within a range of 28±0.1° C. The heat insulating plates 126, 128 arranged respectively between the second housing 52 and the first housing 50 and between the third housing 54 and the first housing 50 restrict the heat transfer between the second housing 52 and the first housing 50 and between the third housing 54 and the first housing 50. As a result, variation of the temperature in the etalon chamber 110 is reduced.

### 1.4.3 Effect

According to the wavelength detection device 2, since the temperature of the first housing 50 is controlled using the rubber heater 120, the temperature variation of the gas in the air gap of each of the fine etalon 60 and the coarse etalon 62, and the temperature variation of the spacer are suppressed. As a result, drift of the wavelength measurement is further suppressed.

### 1.5 Problem

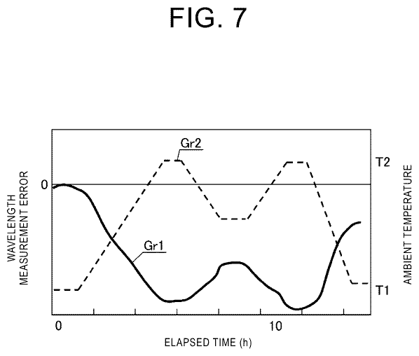

FIG. 7 is a graph showing a test result of the measurement of the wavelength drift when the ambient temperature is changed by placing the monitor module 20 including the wavelength detection device 2 according to the comparative example in a thermostatic bath. FIG. 7 shows the measurement error of the wavelength by inputting light of a mercury lamp introduced from the outside to the monitor module 20. In FIG. 7, graph Gr1 indicated by a thick solid line shows change in the fringe position (mercury order) of the mercury lamp measured by the monitor module 20 of the comparative example as a wavelength variation when the ambient temperature is temporally changed. Graph Gr2 indicated by a broken line in FIG. 7 shows a temperature change of the ambient temperature. The temperature difference (T1 to T2) of the temperature change of the ambient temperature in the temperature range from temperature T1 to temperature T2 shown by the graph Gr2 is Δ7.2° C.

According to the test result shown in FIG. 7, although the temperature control is performed for the first housing 50, it was found that the measured wavelength changes corresponding to the temperature change and the variation range is about 70 fm (femtometer). Therefore, it was found that the wavelength drift may occur in the monitor module 20 of the comparative example, depending on the ambient temperature.

As described above, the wavelength variation may not be suppressed simply by adjusting the temperature of the first housing 50 forming the etalon chamber 110. That is, it was found that, by the temperature control of only the space in which the etalon is arranged, there is a case in which the wavelength drift due to ambient temperature change occurs. It is necessary to realize a wavelength detection device capable of effectively suppressing the wavelength drift due to ambient temperature change.

The inventor of the present disclosure considered the cause of the wavelength drift of the monitor module 20 of the comparative example, and presumed that the second housing 52 is apt to change in temperature due to change in the ambient temperature. It can be presumed that, due to the temperature change of the second housing 52, air in the second housing 52 and the spacer arranged between the lenses of the lens set accommodated in the second housing 52 also change in temperature, the refractive index of the air and a distance between the lenses are changed, and the concentration performance of the lens set is changed. As a result, it is considered that the peak interval of the fringe pattern received by the line sensor 72 also changes to cause the wavelength variation.

### 2. First Embodiment

### 2.1 Configuration

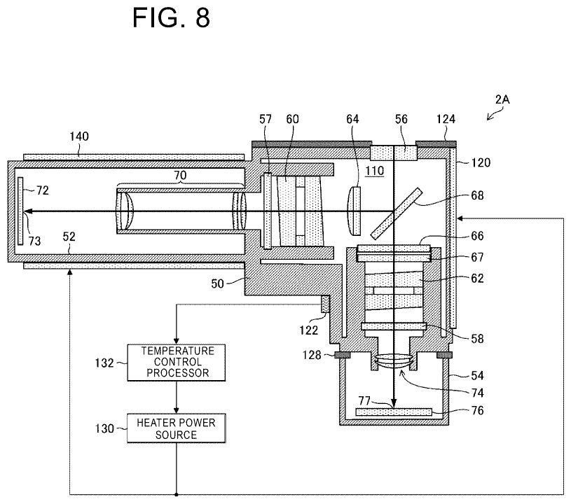

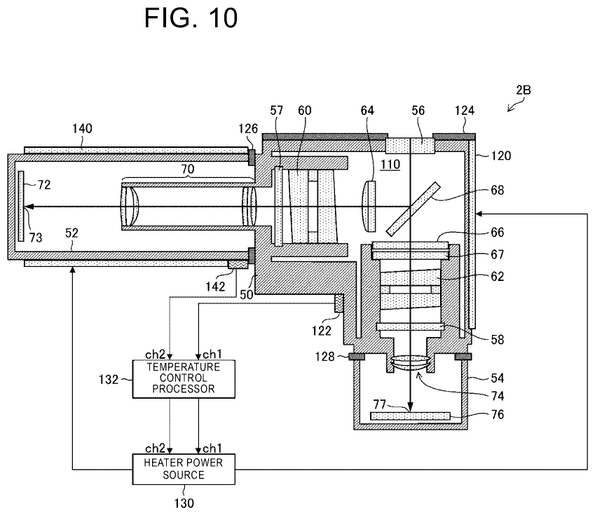

FIG. 8 is a sectional view schematically showing the configuration of a wavelength detection device 2A according to a first embodiment. In the laser device 10, the wavelength detection device 2A shown in FIG. 8 is used instead of the wavelength detection device 2 described with reference to FIG. 6. The configuration of the wavelength detection device 2A shown in FIG. 8 will be described in terms of differences from the configuration shown in FIG. 6. In FIG. 8, the diffusion element 48 is not shown. Similarly, the diffusion element 48 is not shown in FIGS. 10 to 12 described later.

In the wavelength detection device 2A shown in FIG. 8, a rubber heater 140 is arranged on the outer surface of the second housing 52. The rubber heater 140 is preferably arranged so as to cover a portion of the second housing 52 that accommodates the light concentrating optical system 70. In the wavelength detection device 2A, the rubber heater 140 is arranged along the peripheral surface of the outer wall of the second housing 52 so as to cover the periphery of the portion by which the light concentrating optical system 70 is accommodated in the second housing 52 having a cylindrical shape. The second housing 52 is made of a metal having excellent thermal conductivity, such as aluminum.

The heater power source 130 is connected to the rubber heater 140. That is, the heater power source 130 is connected in parallel to the rubber heaters 120, 140.

In the wavelength detection device 2A, the heat insulating plate 126 between the second housing 52 and the first housing 50 is eliminated. That is, the second housing 52 and the first housing 50 are connected to each other in a thermally conductive manner without interposing a heat insulating plate at the connection portion between the second housing 52 and the first housing 50. Other configurations may be similar to those in FIG. 6.

The rubber heater 120 is an example of the “first heater” in the present disclosure. The rubber heater 140 is an example of the “second heater” in the present disclosure. The fine etalon 60 is an example of the “first etalon” in the present disclosure. The coarse etalon 62 is an example of the “second etalon” in the present disclosure. The light concentrating optical system 70 is an example of the “first light concentrating optical system” in the present disclosure. The light concentrating optical system 74 is an example of the “second light concentrating optical system” in the present disclosure. The line sensor 72 is an example of the “first sensor” in the present disclosure. The line sensor 76 is an example of the “second sensor” in the present disclosure. The temperature control processor 132 is an example of the “processor” in the present disclosure. The temperature sensor 122 is an example of the “first temperature sensor” in the present disclosure. The heat insulating plate 128 is an example of the “first heat insulating material” in the present disclosure. The window 56 is an example of the “first window” in the present disclosure. The window 57 is an example of the “second window” in the present disclosure. The window 58 is an example of the “third window” in the present disclosure.

### 2.2 Operation

The temperature control processor 132 controls the rubber heaters 120, 140 so that the temperature measured by the temperature sensor 122 is maintained within a constant temperature range. That is, the temperature control processor 132 controls the heat amounts of the rubber heaters 120, 140 via the heater power source 130 so that the temperature measured by the temperature sensor 122 is within the constant temperature range. The constant temperature range as a control target of the temperature adjustment may be, for example, in the range of 28±0.1° C. Here, “28° C.” is an example of a set temperature that defines a value of the center of the target temperature range, and “±0.1° C.” is an example of a range of a temperature difference allowed with respect to the set temperature. From the viewpoint of achieving high accuracy temperature maintenance, it is desirable to set a narrow temperature range within ±0.1° C. with respect to the set temperature as the target temperature range.

The rubber heater 120 controls the temperature of the first housing 50, and the rubber heater 140 controls the temperature of the second housing 52 in the same manner. In this case, the control may be feedback control. Since the heat insulating plate is not interposed at the connection portion between the first housing 50 and the second housing 52, heat is conducted to both the first housing 50 and the second housing 52.

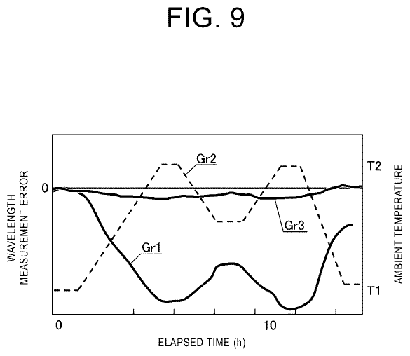

FIG. 9 shows a test result of measurement of the wavelength drift based on the fringe position (mercury order) of the mercury lamp using the wavelength detection device 2A according to the first embodiment. The test method is the same as that described with reference to FIG. 7. That is, instead of the wavelength detection device 2 of FIG. 1, the monitor module 20 including the wavelength detection device 2A according to the first embodiment was placed in a thermostatic bath to change the ambient temperature, and the wavelength drift was measured. Graph Gr3 indicated by a bold solid line in FIG. 9 is a graph showing the wavelength drift of the wavelength detection device 2A according to the first embodiment. Graph Gr2 indicated by a broken line in FIG. 9 shows a temperature change of the ambient temperature. Graph Gr1 of FIG. 7 is also shown in FIG. 9 for comparison.

According to the wavelength detection device 2 of the comparative example, the wavelength drift of 70 fm occurred, but according to the wavelength detection device 2A of the first embodiment, the wavelength drift can be reduced to 7 fm.

### 2.3 Effect

According to the wavelength detection device 2A of the first embodiment, since the temperature of the second housing 52 is controlled in addition to the temperature control of the first housing 50, the temperature variation of the air in the second housing 52 and the spacer fixing the lenses of the light concentrating optical system 70 is suppressed, and the temperature variation of the first housing 50 and the second housing 52 is reduced. As a result, drift of wavelength measurement using the wavelength detection device 2A is suppressed.

### 3. Second Embodiment

### 3.1 Configuration

FIG. 10 is a sectional view schematically showing the configuration of a wavelength detection device 2B according to a second embodiment. The configuration of the wavelength detection device 2B shown in FIG. 10 will be described in terms of differences from the wavelength detection device 2A according to the first embodiment shown in FIG. 8.

In the wavelength detection device 2B according to the second embodiment, a temperature sensor 142 is arranged on the outer surface of the second housing 52. The temperature sensor 142 is connected to the temperature control processor 132. Each of the temperature control processor 132 and the heater power source 130 has a multi-channel input/output configuration. For example, the temperature sensor 122 is connected to an input of a first channel (ch1) of the temperature control processor 132, and the temperature sensor 142 is connected to an input of a second channel (ch2) of the temperature control processor 132. An output of the first channel of the temperature control processor 132 is connected to an input of a first channel of the heater power source 130. An output of the second channel of the temperature control processor 132 is connected to an input of a second channel of the heater power source 130. The rubber heater 120 is connected to an output of the first channel of the heater power source 130. The rubber heater 140 is connected to an output of the second channel of the heater power source 130.

The heat insulating plate 126 is arranged between the first housing 50 and the second housing 52. Other configurations may be similar to those in FIG. 8. The temperature sensor 142 is an example of the “second temperature sensor” in the present disclosure. The heat insulating plate 126 is an example of the “second heat insulating material” in the present disclosure. The heat insulating plate 124 is an example of the “third heat insulating material” in the present disclosure.

### 3.2 Operation

In the wavelength detection device 2B according to the second embodiment, the rubber heater 120 for adjusting the temperature of the first housing 50 and the rubber heater 140 for adjusting the temperature of the second housing 52 are individually controlled. The temperature control processor 132 controls the rubber heater 120 to maintain the temperature measured by the temperature sensor 122 within a constant temperature range. The temperature control processor 132 also controls the rubber heater 140 to maintain the temperature measured by the temperature sensor 142 within a constant temperature range. That is, the temperature control processor 132 controls the heat amount of the rubber heater 120 via the heater power source 130 so that the temperature measured by the temperature sensor 122 is within the constant temperature range, and controls the heat amount of the rubber heater 140 via the heater power source 130 so that the temperature measured by the temperature sensor 142 is within the constant temperature range.

Thus, the rubber heater 120 is independently controlled based on the temperature measured by the temperature sensor 122, and the rubber heater 140 is independently controlled based on the temperature measured by the temperature sensor 142. Each control may be feedback control. In this control, the target temperature of the first housing 50 and the target temperature of the second housing 52 may be the same, or may be different from each other. For example, if input-output heat conditions of the first housing 50 and the second housing 52 are different depending on the arrangement structure of the first housing 50 and the ambient temperature distribution, the rubber heater 120 and the rubber heater 140 may be controlled to different target temperatures so that the temperatures of the fine etalon 60, the coarse etalon 62 and the light concentrating optical system 70 are each within a constant temperature range.

Further, instead of the multi-channel temperature control processor 132, a plurality of temperature control processors may be used, and different processors may be connected to the temperature sensors 122, 142, respectively. In this case, the processor to which the temperature sensor 122 is connected is configured to control the heat amount of the rubber heater 120, and the processor to which the temperature sensor 142 is connected is configured to control the heat amount of the rubber heater 140.

The heat insulating plate 126 interposed at the connection portion between the first housing 50 and the second housing 52 restricts the heat conduction between the first housing 50 and the second housing 52.

### 3.3 Effect

According to the wavelength detection device 2B of the second embodiment, since the temperatures of the first housing 50 and the second housing 52 are controlled independently, the temperature adjustment accuracy of the first housing 50 and the second housing 52 is improved. According to the second embodiment, as compared with the first embodiment, since the temperature of the second housing 52 is controlled with higher accuracy, the temperature variation of the air in the second housing 52 and the temperature variation of the spacer fixing the lenses of the light concentrating optical system 70 accommodated in the second housing 52 are further suppressed. As a result, drift of the wavelength measurement is further suppressed.

### 3.4 Modification

### 3.4.1 Configuration

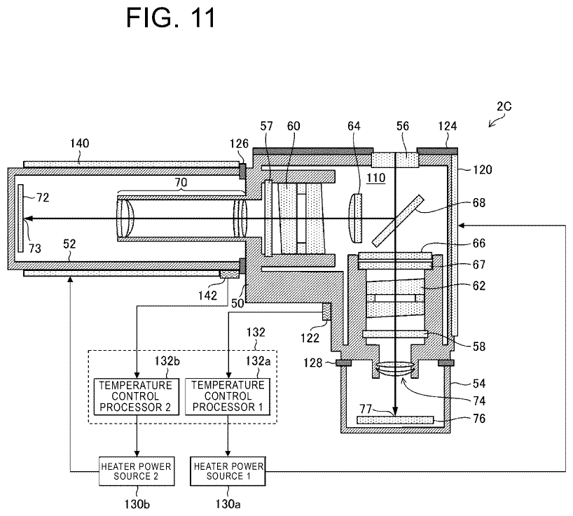

FIG. 11 is a sectional view schematically showing the configuration of a wavelength detection device 2C according to a modification of the second embodiment. The configuration of the wavelength detection device 2C shown in FIG. 11 will be described in terms of differences from the wavelength detection device 2B shown in FIG. 10.

The temperature control processor 132 is configured to include a plurality of temperature control processors 132a, 132b such that different temperature control processors 132a, 132b are connected to the temperature sensors 122, 142, respectively.

The temperature control processors 132a, 132b are connected to heater power sources 130a, 130b, respectively. The heater power source 130a is connected to the rubber heater 120. The heater power source 130b is connected to the rubber heater 140. Other configurations may be similar to those in FIG. 10.

The temperature control processor 132a is an example of the “first processor” in the present disclosure, and the temperature control processor 132b is an example of the “second processor” in the present disclosure. In FIG. 11, the temperature control processor 132a is referred to as a “temperature control processor 1”, and the temperature control processor 132b is referred to as a “temperature control processor 2”. Further, the heater power source 130a is referred to as a “heater power source 1”, and the heater power source 130b is referred to as a “heater power source 2”.

### 3.4.2 Operation

The temperature control processor 132a to which the temperature sensor 122 is connected controls the heat amount of the rubber heater 120. The temperature control processor 132b to which the temperature sensor 142 is connected controls the heat amount of the rubber heater 140.

Other operation may be similar to the operation of the wavelength detection device 2B according to the second embodiment.

### 3.4.3 Effect

According to the wavelength detection device 2C, similar effects to those of the wavelength detection device 2B according to the second embodiment can be obtained.

### 4. Third Embodiment

### 4.1 Configuration

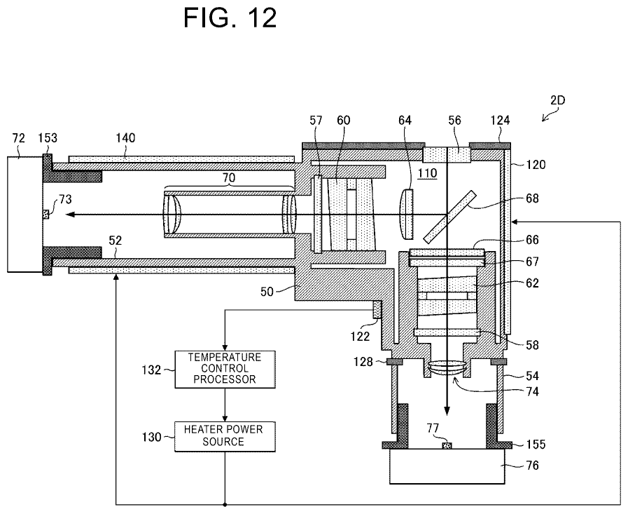

FIG. 12 is a sectional view schematically showing the configuration of a wavelength detection device 2D according to a third embodiment. The configuration of the wavelength detection device 2D shown in FIG. 12 will be described in terms of differences from the wavelength detection device 2A shown in FIG. 8.

Although FIG. 8 shows an example in which the line sensors 72, 76 are accommodated in the second housing 52 and the third housing 54, respectively, the line sensors 72, 76 may be configured separately from the second housing 52 and the third housing 54, respectively.

In the wavelength detection device 2D shown in FIG. 12, the line sensor 72 may be fixed to an end part of a connection pipe 153 and connected to the second housing 52 via the connection pipe 153. Similarly, the line sensor 76 may be fixed to an end part of a connection pipe 155 and connected to the third housing 54 via the connection pipe 155. That is, the line sensors 72, 76 may be arranged outside the second housing 52 and the third housing 54, respectively. Other configurations may be similar to those in FIG. 8.

### 4.2 Operation

Operation of the wavelength detection device 2D may be similar to the operation of the wavelength detection device 2A according to the first embodiment.

### 4.3 Effect

According to the wavelength detection device 2D of the third embodiment, similar effects to those of the wavelength detection device 2A according to the first embodiment can be obtained.

### 4.4 Modification

The attachment configuration of the line sensors 72, 76 using the connection pipes 153, 155 described with reference to FIG. 12 may be applied to the wavelength detection device 2B of FIG. 10 or the wavelength detection device 2C of FIG. 11.

### 5. Electronic Device Manufacturing Method

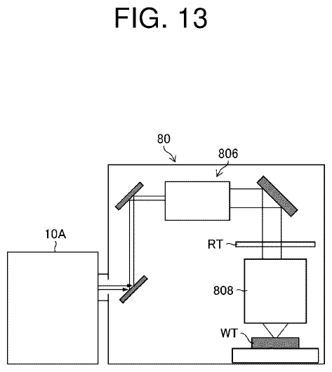

FIG. 13 schematically shows the configuration of the exposure apparatus 80. The exposure apparatus 80 includes an illumination optical system 806 and a projection optical system 808. The laser device 10A may be a laser device including any one of the wavelength detection devices 2A, 2B, 2C, 2D described as the first to third embodiments and the modifications thereof instead of the wavelength detection device 2 in the laser device 10 described with reference to FIG. 1. The laser device 10A generates laser light and outputs the laser light to the exposure apparatus 80. The illumination optical system 806 illuminates a reticle pattern of a reticle (not shown) arranged on a reticle stage RT with laser light incident from the laser device 10A. The projection optical system 808 causes the laser light transmitted through the reticle to be imaged as being reduced and projected on a workpiece (not shown) arranged on a workpiece table WT. The workpiece is a photosensitive substrate such as a semiconductor wafer on which photoresist is applied.

The exposure apparatus 80 synchronously translates the reticle stage RT and the workpiece table WT to expose the workpiece to the laser light reflecting the reticle pattern. After the reticle pattern is transferred onto the semiconductor wafer by the exposure process described above, a semiconductor device can be manufactured through a plurality of processes. The semiconductor device is an example of the “electronic device” in the present disclosure.

### 6. Others

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious to those skilled in the art that the embodiments of the present disclosure would be appropriately combined.

The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.” Further, “at least one of A, B, and C” should be interpreted to mean any of A, B, C, A+B, A+C, B+C, and A+B+C as well as to include combinations of any thereof and any other than A, B, and C.

What is claimed is:

1. A wavelength detection device for an excimer laser, comprising:
a first housing accommodating a first etalon;
a first heater arranged on an outer wall of the first housing, and configured to heat the first housing;
a second housing connected to the first housing, and accommodating a first light concentrating optical system configured to cause light output from the first etalon to be imaged on a first sensor;
a second heater arranged on an outer wall of the second housing, and configured to heat the second housing; and
a processor configured to control a temperature of the first housing and a temperature of the second housing using the first heater and the second heater.

2. The wavelength detection device according to claim 1,
wherein the first housing further accommodates a second etalon having a free spectral range wider than the first etalon, and
the wavelength detection device further includes a third housing connected to the first housing, and accommodating a second light concentrating optical system configured to cause light output from the second etalon to be imaged on a second sensor.

3. The wavelength detection device according to claim 2,
wherein a first heat insulating material is arranged between the first housing and the third housing.

4. The wavelength detection device according to claim 2,
wherein a focal length of the second light concentrating optical system is shorter than a focal length of the first light concentrating optical system.

5. The wavelength detection device according to claim 1,
further comprising a first temperature sensor configured to measure the temperature of the first housing,
wherein the processor controls the first heater and the second heater so that a temperature measured by the first temperature sensor is maintained within a constant temperature range.

6. The wavelength detection device according to claim 5,
wherein a heat insulating material is not interposed between the first housing and the second housing at a connection portion between the first housing and the second housing.

7. The wavelength detection device according to claim 5,
wherein the constant temperature range is a temperature range within ±0.1° C. with respect to a set temperature of a control target.

8. The wavelength detection device according to claim 1, further comprising:
a first temperature sensor configured to measure the temperature of the first housing, and
a second temperature sensor configured to measure the temperature of the second housing,
wherein the processor controls the first heater so that a temperature measured by the first temperature sensor is maintained within a constant temperature range and the second heater so that a temperature measured by the second temperature sensor is maintained within the constant temperature range.

9. The wavelength detection device according to claim 8,
wherein the processor includes a first processor connected to the first temperature sensor and a heater power source for the first heater, and a second processor connected to the second temperature sensor and a heater power source for the second heater.

10. The wavelength detection device according to claim 8,
wherein a second heat insulating material is arranged between the first housing and the second housing.

11. The wavelength detection device according to claim 1,
wherein the second heater is arranged along a peripheral surface of the outer wall of the second housing so as to cover a periphery of a portion of the second housing by which the first light concentrating optical system is accommodated.

12. The wavelength detection device according to claim 1,
wherein nitrogen is enclosed at an internal space of the first housing.

13. The wavelength detection device according to claim 1,
wherein the first light concentrating optical system is configured by a lens set.

14. The wavelength detection device according to claim 1,
wherein the first housing and the second housing are made of aluminum.

15. The wavelength detection device according to claim 1,
wherein the first housing includes a first window configured to allow laser light to enter the first housing, and a second window configured to output light transmitted through the first etalon to an outside of the first housing, and
the light transmitted through the first etalon is transmitted through the second window and enters the first light concentrating optical system.

16. The wavelength detection device according to claim 15,
wherein a third heat insulating material is arranged on a surface, on which the first window is arranged, of the outer wall of the first housing.

17. The wavelength detection device according to claim 2,
wherein the first housing includes a first window configured to allow laser light to enter the first housing, and a third window configured to output light transmitted through the second etalon to the outside of the first housing, and
the light transmitted through the second etalon is transmitted through the third window and enters the second light concentrating optical system.

18. A laser device comprising;
a laser resonator configured to output ultraviolet laser light; and
a wavelength detection device configured to detect a wavelength of the laser light,
the wavelength detection device comprising:
a first housing accommodating a first etalon;
a first heater arranged on an outer wall of the first housing, and configured to heat the first housing;
a second housing connected to the first housing, and accommodating a first light concentrating optical system configured to cause light output from the first etalon to be imaged on a first sensor;
a second heater arranged on an outer wall of the second housing, and configured to heat the second housing; and
a processor configured to control a temperature of the first housing and a temperature of the second housing using the first heater and the second heater.

19. An electronic device manufacturing method, comprising:
generating laser light using a laser device;
outputting the laser light to an exposure apparatus; and
exposing a photosensitive substrate to the laser light in the exposure apparatus to manufacture an electronic device,
the laser device comprising:
a laser resonator configured to output the ultraviolet laser light; and
a wavelength detection device configured to detect a wavelength of the laser light, and
the wavelength detection device comprising:
a first housing accommodating a first etalon;
a first heater arranged on an outer wall of the first housing, and configured to heat the first housing;
a second housing connected to the first housing, and accommodating a first light concentrating optical system configured to cause light output from the first etalon to be imaged on a first sensor;
a second heater arranged on an outer wall of the second housing, and configured to heat the second housing; and
a processor configured to control a temperature of the first housing and a temperature of the second housing using the first heater and the second heater.
